(19) United States
(12) Patent Application Publication
(10) Pub. No.: US 2022/0155119 A1
(43) Pub. Date: May 19, 2022

(54) AIR FLOW RATE MEASUREMENT DEVICE

(71) Applicant: DENSO CORPORATION, Kariya-city (JP)

(72) Inventor: Taichi WATANABE, Kariya-city (JP)

(21) Appl. No.: 17/666,119

(22) Filed: Feb. 7, 2022

Related U.S. Application Data
(63) Continuation of application No. PCT/JP2020/033287, filed on Sep. 2, 2020.

(30) Foreign Application Priority Data
Sep. 4, 2019 (JP) 2019-161245

(51) Int. Cl. G01F 1/684; G01F 1/696; G01F 15/14; F02M 35/10

(52) U.S. Cl. CPC G01F 1/6842; F02M 35/10386; G01F 15/14; G01F 1/696

(57) ABSTRACT

In a flow rate measurement device, a flow rate sensing device outputs a signal which corresponds to a flow rate of air flowing in a flow rate measurement passage, and a physical quantity sensing device outputs a signal which corresponds to a physical quantity of the air flowing in a physical quantity measurement passage communicated with a physical quantity measurement passage inlet and a physical quantity measurement passage outlet at a housing. The physical quantity measurement passage has a physical quantity measurement passage inner surface formed at a part of the physical quantity measurement passage located on a side where a back surface is placed. The physical quantity measurement passage outlet has an outlet rectifying surface that is connected to a lateral surface of the housing and an end part of the physical quantity measurement passage inner surface located on a side where the lateral surface is placed.

### CROSS REFERENCE TO RELATED APPLICATIONS

This application is a continuation application of International Patent Application No. PCT/JP2020/033287 filed on Sep. 2, 2020, which designated the U.S. and claims the benefit of priority from Japanese Patent Application No. 2019-161245 filed on Sep. 4, 2019. The entire disclosures of all of the above applications are incorporated herein by reference.

### TECHNICAL FIELD

The present disclosure relates to an air flow rate measurement device.

### BACKGROUND

Previously, there has been proposed a sensor device that includes a flow rate sensor, which measures a flow rate of air, and a temperature sensor, which measures the temperature of the air.

### SUMMARY

This section provides a general summary of the disclosure, and is not a comprehensive disclosure of its full scope or all of its features.

According to the present disclosure, there is provided an air flow rate measurement device that includes a housing, a flow rate sensing device and a physical quantity sensing device. The flow rate sensing device is configured to output a signal which corresponds to a flow rate of air flowing in a flow rate measurement passage of the housing. The physical quantity sensing device is configured to output a signal which corresponds to a physical quantity of the air flowing in a physical quantity measurement passage of the housing that is communicated with a physical quantity measurement passage inlet and a physical quantity measurement passage outlet of the housing. The physical quantity measurement passage has a physical quantity measurement passage inner surface that is formed at a part of the physical quantity measurement passage located on a side where a back surface of the housing is placed. The physical quantity measurement passage outlet has an outlet rectifying surface that is connected to a lateral surface of the housing and an end part of the physical quantity measurement passage inner surface located on a side where the lateral surface is placed, and the physical quantity measurement passage outlet is configured to generate a flow of the air in a direction along the lateral surface at a flow of the air in the physical quantity measurement passage outlet when the air in the physical quantity measurement passage outlet flows along the outlet rectifying surface.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic diagram of an engine system, in which an air flow rate measurement device of respective embodiments is used.

FIG. 2 is a front view of the air flow rate measurement device of a first embodiment.

FIG. 3 is a side view of the air flow rate measurement device.

FIG. 4 is another side view of the air flow rate measurement device.

FIG. 5 is a cross-sectional view taken along line V-V in FIG. 2.

FIG. 6 is an enlarged cross-sectional view taken along line VI-VI in FIG. 2.

FIG. 7 is a perspective enlarged view of a primary physical quantity measurement passage outlet.

FIG. 8 is an enlarged cross-sectional view taken along line VIII-VIII in FIG. 7.

FIG. 9 is an enlarged partial cross-sectional view taken along line IX-IX in FIG. 7.

FIG. 10 is an enlarged partial cross-sectional view taken along line X-X in FIG. 7.

FIG. 11 is an enlarged partial cross-sectional view taken along line XI-Xl in FIG. 7.

FIG. 12 is an enlarged partial cross-sectional view taken along line Xl -XII in FIG. 7.

FIG. 13 is a perspective view of a secondary physical quantity measurement passage outlet.

FIG. 14 is an enlarged cross-sectional view taken along line XIV-XIV in FIG. 2.

FIG. 15 is a side view of the air flow rate measurement device.

FIG. 16 is another side view of the air flow rate measurement device.

FIG. 17 is a cross-sectional view of an air flow rate measurement device of a second embodiment.

FIG. 18 is a cross-sectional view of an air flow rate measurement device of a third embodiment.

FIG. 19 is a side view of an air flow rate measurement device of another embodiment.

FIG. 20 is a side view of an air flow rate measurement device of the other embodiment.

FIG. 21 is a cross-sectional view of a circuit board and a physical quantity sensing device of an air flow rate measurement device of another embodiment.

### DETAILED DESCRIPTION

Previously, there has been proposed a sensor device that includes a flow rate sensor, which measures a flow rate of air, and a temperature sensor, which measures the temperature of the air.

In the sensor device, the air, which is measured with the temperature sensor, is discharged from a hole that is formed at a lateral surface cover. At this time, in some cases, a direction of the flow of the air, which is discharged from the hole of the lateral surface cover, differs from a direction of the flow of the air around the sensor device. Therefore, the air, which flows around the sensor device, is likely to be disturbed when the air, which is discharged from the hole of the lateral surface cover, merges with the air which flows around the sensor device. Therefore, the pressure loss of the air, which flows around the sensor device, may possibly become relatively large.

According to one aspect of the present disclosure, there is provided an air flow rate measurement device including:

a housing that has:
a base surface;
a back surface that is opposed to the base surface;
a lateral surface that is connected to an end part of the base surface and an end part of the back surface;
a flow rate measurement passage inlet that is formed at the base surface;
a flow rate measurement passage outlet that is formed at the back surface;
a flow rate measurement passage that is communicated with the flow rate measurement passage inlet and the flow rate measurement passage outlet;
a physical quantity measurement passage inlet that is formed at the base surface;
a physical quantity measurement passage outlet that is formed at the lateral surface; and
a physical quantity measurement passage that is communicated with the physical quantity measurement passage inlet and the physical quantity measurement passage outlet;

a flow rate sensing device that is configured to output a signal which corresponds to a flow rate of air flowing in the flow rate measurement passage; and

a physical quantity sensing device that is configured to output a signal which corresponds to a physical quantity of the air flowing in the physical quantity measurement passage, wherein:

the physical quantity measurement passage has a physical quantity measurement passage inner surface that is formed at a part of the physical quantity measurement passage located on a side where the back surface is placed; and

the physical quantity measurement passage outlet has an outlet rectifying surface that is connected to the lateral surface and an end part of the physical quantity measurement passage inner surface located on a side where the lateral surface is placed, and the physical quantity measurement passage outlet is configured to generate a flow of the air in a direction along the lateral surface at a flow of the air in the physical quantity measurement passage outlet when the air in the physical quantity measurement passage outlet flows along the outlet rectifying surface.

With the above configuration, the pressure loss of the air, which flows around the air flow rate measurement device, is reduced.

Hereinafter, embodiments of the present disclosure will be described with reference to the drawings. In each of the following embodiments, the same or equivalent portions will be indicated by the same reference signs, and redundant description thereof will be omitted for the sake of simplicity.

### First Embodiment

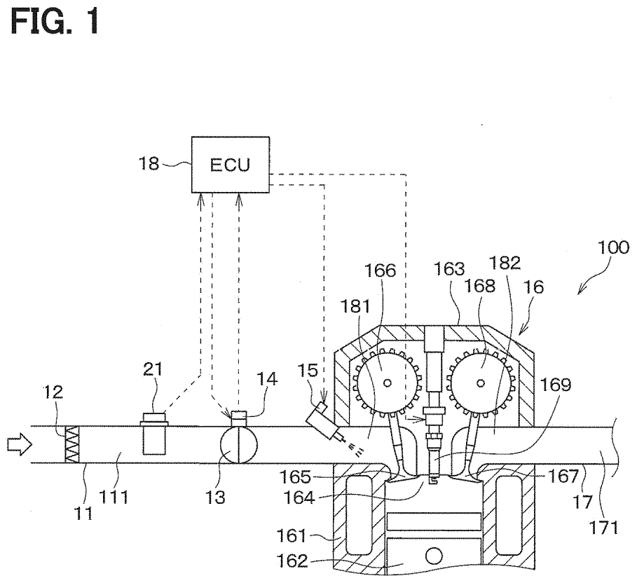

An air flow rate measurement device 21 is used, for example, in an air intake system of an engine system 100 installed to a vehicle. First of all, this engine system 100 will be described. Specifically, as shown in FIG. 1, the engine system 100 includes an air intake pipe 11, an air cleaner 12, an airflow rate measurement device 21, a throttle valve 13, a throttle sensor 14, injectors 15, an engine 16, an exhaust pipe 17 and an electronic control device 18. In this description, intake air refers to air that is drawn into the engine 16. Furthermore, exhaust gas refers to gas that is discharged from the engine 16.

The air intake pipe 11 is shaped into a cylindrical tubular form and has an air intake passage 111. The air intake passage 111 is configured to conduct the air to be drawn into the engine 16.

The air cleaner 12 is installed in the air intake pipe 11 at an upstream side section of the air intake passage 111, which is located on an upstream side in a flow direction of the air flowing in the air intake passage 111. Furthermore, the air cleaner 12 is configured to remove foreign objects, such as dust, contained in the air flowing in the air intake passage 111.

The air flow rate measurement device 21 is located on a downstream side of the air cleaner 12 in the flow direction of the air flowing in the air intake passage 111. The air flow rate measurement device 21 is configured to measure the flow rate of the air, which flows in the air intake passage 111, at a location between the air cleaner 12 and the throttle valve 13. In this embodiment, the air flow rate measurement device 21 is also configured to measure a physical quantity of the air that flows in the air intake passage 111. Details of the air flow rate measurement device 21 will be described later. In this embodiment, the physical quantity of the air, which flows in the air intake passage 111, is a physical quantity that is different from the flow rate of the air, which flows in the air intake passage 111, and this physical quantity is the temperature of the air as discussed later in detail.

The throttle valve 13 is located on a downstream side of the air flow rate measurement device 21 in the flow direction of the air flowing in the air intake passage 111. Furthermore, the throttle valve 13 is shaped into a circular disk form and is rotated by an electric motor (not shown). The throttle valve 13 is configured to adjust a size of a passage cross-sectional area of the air intake passage 111 and thereby adjust the flow rate of the air to be drawn into the engine 16 through rotation of the throttle valve 13. Here, the passage cross-sectional area refers to a cross-sectional area of the flow passage.

The throttle sensor 14 is configured to output a measurement signal, which corresponds to an opening degree of the throttle valve 13, to the electronic control device 18.

The injector 15 is configured to inject the fuel into a combustion chamber 164 of the engine 16 based on a signal outputted from the electronic control device 18 described later.

The engine 16 is an internal combustion engine where a mixture gas, which is a mixture of the air flowing from the air intake passage 111 through the throttle valve 13 and the fuel injected from the injector 15, is combusted in the combustion chamber 164. An explosive force, which is generated by this combustion, causes a piston 162 of the engine 16 to reciprocate in a cylinder 161. Specifically, the engine 16 includes cylinders 161, pistons 162, a cylinder head 163, combustion chambers 164, intake valves 165, an intake valve drive device 166, exhaust valves 167, an exhaust valve drive device 168 and spark plugs 169.

The cylinder 161 is shaped in a tubular form and receives the piston 162. The piston 162 is configured to reciprocate in the cylinder 161 in an axial direction of the cylinder 161. The cylinder head 163 is installed at upper portions of the cylinders 161. Furthermore, the cylinder head 163 is connected to the air intake pipe 11 and the exhaust pipe 17 and has a first cylinder passage 181 and a second cylinder passage 182. The first cylinder passage 181 is communicated with the air intake passage 111. The second cylinder passage 182 is communicated with an exhaust passage 171 of the exhaust pipe 17 described later. The combustion chamber 164 is defined by the cylinder 161, a top surface of the piston 162 and a lower surface of the cylinder head 163. The intake valve 165 is placed in the first cylinder passage 181 and is configured to be driven by the intake valve drive device 166 to open and close the combustion chamber 164 at the first cylinder passage 181 side. The exhaust valve 167 is placed in the second cylinder passage 182 and is configured to be driven by the exhaust valve drive device 168 to open and close the combustion chamber 164 at the second cylinder passage 182 side.

The spark plug 169 is configured to ignite the mixture gas of the combustion chamber 164, which is the mixture of the air flowing from the air intake passage 111 through the throttle valve 13 and the fuel injected from the injector 15, based on the signal outputted from the electronic control device 18.

The exhaust pipe 17 is shaped in a cylindrical tubular form and has the exhaust passage 171. The exhaust passage 171 conducts the gas which is combusted in the combustion chambers 164. The gas, which flows in the exhaust passage 171, is purified by an exhaust gas purification device (not shown).

The electronic control device 18 includes a microcomputer as its main component and thereby has a CPU, a ROM, a RAM, an I/O device and a bus line for connecting these devices. Here, for example, the electronic control device 18 controls the opening degree of the throttle valve 13 based on, for example, the flow rate of the air and the physical quantity of the air measured with the air flow rate measurement device 21 and the current opening degree of the throttle valve 13. Furthermore, the electronic control device 18 controls a fuel injection amount of the respective injectors 15 and ignition timing of the respective spark plugs 169 based on, for example, the flow rate of the air and the physical quantity of the air measured with the air flow rate measurement device 21 and the current opening degree of the throttle valve 13. In FIG. 1, the electronic control device 18 is indicated as an ECU.

The engine system 100 has the above-described structure. Next, the air flow rate measurement device 21 will be described in detail.

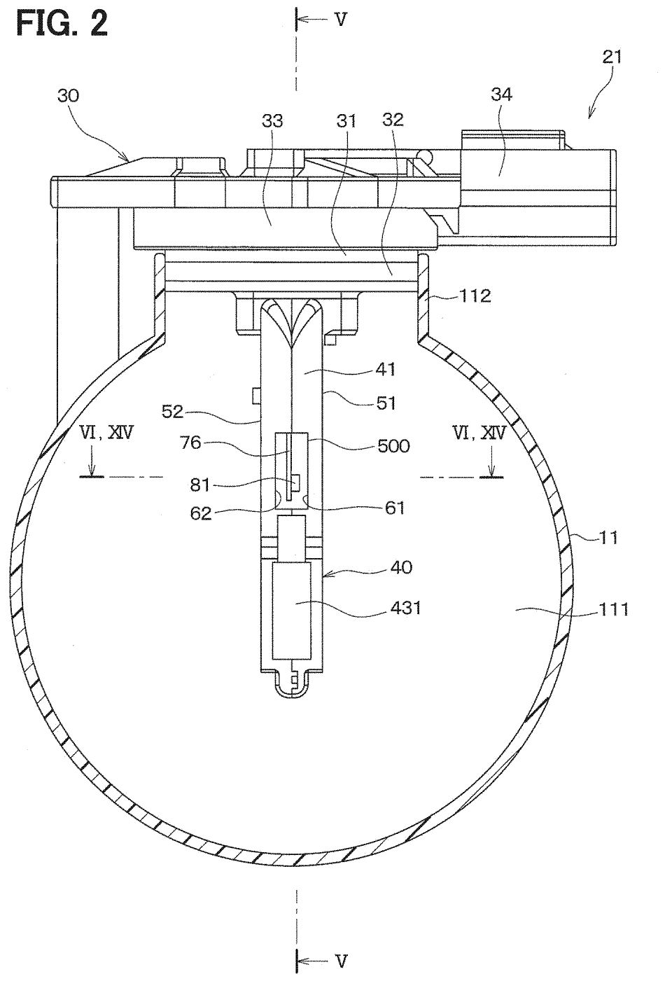

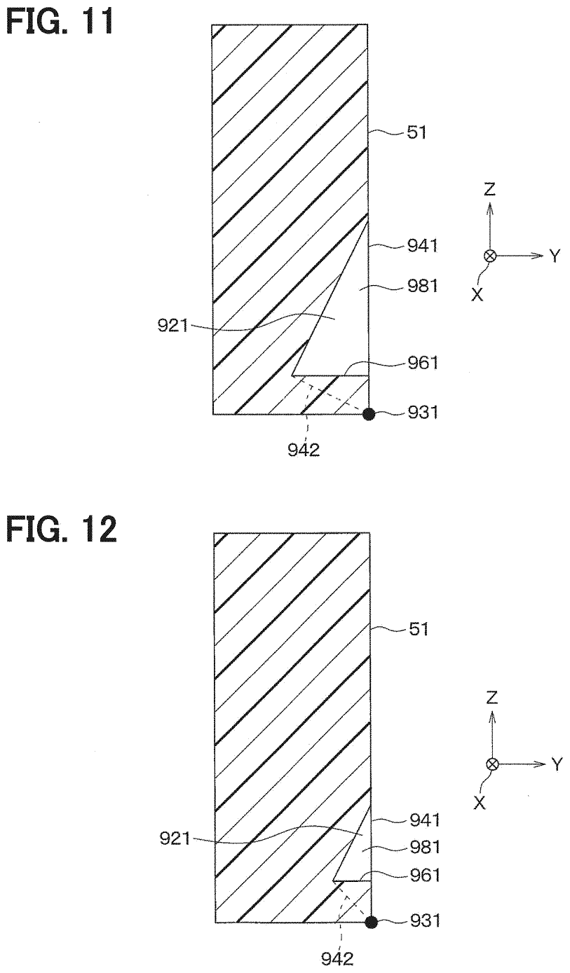

As shown in FIGS. 2 to 13, the air flow rate measurement device 21 includes a housing 30, a flow rate sensing device 75, a circuit board 76 and a physical quantity sensing device 81.

As shown in FIG. 2, the housing 30 is installed to a pipe extension 112 that is connected to a peripheral wall of the air intake pipe 11. The pipe extension 112 is shaped in a cylindrical tubular form and extends from the peripheral wall of the air intake pipe 11 in a radial direction of the air intake pipe 11 from a radially inner side toward a radially outer side. Furthermore, the housing 30 includes a holding portion 31, a seal member 32, a lid 33, a connector cover 34, terminals 35 and a bypass portion 40.

The holding portion 31 is shaped in a cylindrical tubular form and is fixed to the pipe extension 112 when an outer surface of the holding portion 31 is fitted to an inner surface of the pipe extension 112, Furthermore, a groove, into which the seal member 32 is fitted, is formed at an outer peripheral surface of the holding portion 31.

The seal member 32 is for example, an O-ring and is installed in the groove of the holding portion 31. The seal member 32 closes a passage in the pipe extension 112 when the seal member 32 contacts the pipe extension 112, Thereby, leakage of the air, which flows in the air intake passage 111, to the outside through the pipe extension 112 is limited.

The lid 33 is shaped in a bottomed tubular form and is connected to the holding portion 31 in an axial direction of the holding portion 31. Furthermore, a length of the lid 33, which is measured in a radial direction of the holding portion 31, is larger than a diameter of the pipe extension 112, and the lid 33 closes a hole of the pipe extension 112.

The connector cover 34 is connected to the lid 33 and extends from a radially inner side toward a radially outer side in the radial direction of the holding portion 31. Furthermore, the connector cover 34 is shaped in a tubular form and receives one end parts of the terminals 35.

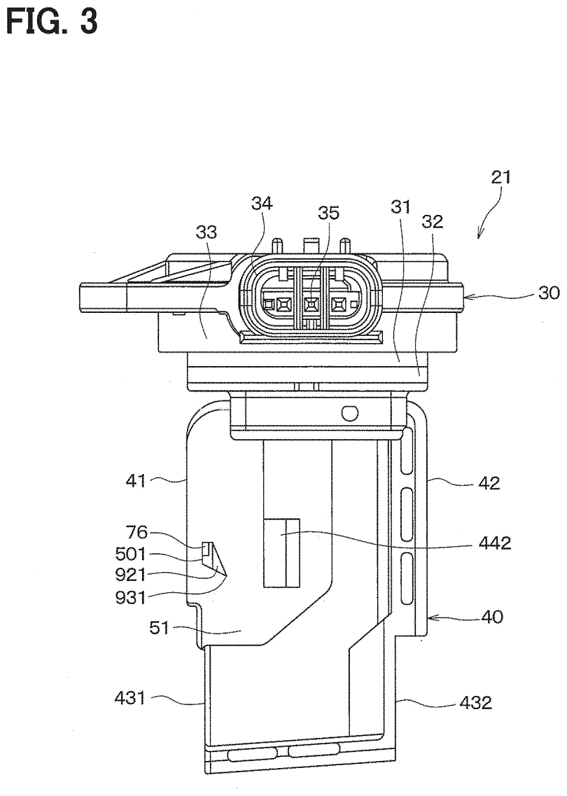

As shown in FIG. 3, the one end parts of the terminals 35 are received in the connector cover 34. Furthermore, although not depicted in the drawing, the one end parts of the terminals 35 are connected to the electronic control device 18. Also, center parts of the terminals 35 are received in the lid 33 and the holding portion 31. The other end parts of corresponding ones of the terminals 35 are connected to the circuit board 76 described later.

The bypass portion 40 includes a plurality of passages and is shaped in a planar form. Specifically, as shown in FIGS. 2 to 6, the bypass portion 40 includes a housing base surface 41, a housing back surface 42, a primary housing lateral surface 51 and a secondary housing lateral surface 52. Furthermore, the bypass portion 40 includes a flow rate measurement main passage inlet (flow rate measurement passage inlet) 431, a flow rate measurement main passage outlet (flow rate measurement passage outlet) 432, a flow rate measurement main passage (flow rate measurement passage) 43, a flow rate measurement sub-passage inlet 441, a flow rate measurement sub-passage (flow rate measurement passage) 44 and a plurality of flow rate measurement sub-passage outlets 442, Also, the bypass portion 40 includes a physical quantity measurement passage inlet 500, a physical quantity measurement passage 50, a primary physical quantity measurement passage outlet 501 and a secondary physical quantity measurement passage outlet 502. In the following description, a side of the bypass portion 40, at which the terminals 35 are placed, will be referred to as an upper side. Furthermore, another side of the bypass portion 40, which is opposite to the terminals 35, will be referred to as a lower side.

The housing base surface 41 is located on an upstream side in the flow direction of the air flowing in the air intake passage 111. The housing back surface 42 is located on a side that is opposite to the housing base surface 41. The primary housing lateral surface 51 serves as a primary lateral surface and is connected to one end part of the housing base surface 41 and one end part of the housing back surface 42. The secondary housing lateral surface 52 serves as a secondary lateral surface and is connected to another end part of the housing base surface 41 and another end part of the housing back surface 42, which are opposite to the primary housing lateral surface 51. Furthermore, the housing base surface 41, the housing back surface 42, the primary housing lateral surface 51 and the secondary housing lateral surface 52 are respectively shaped in a stepped form.

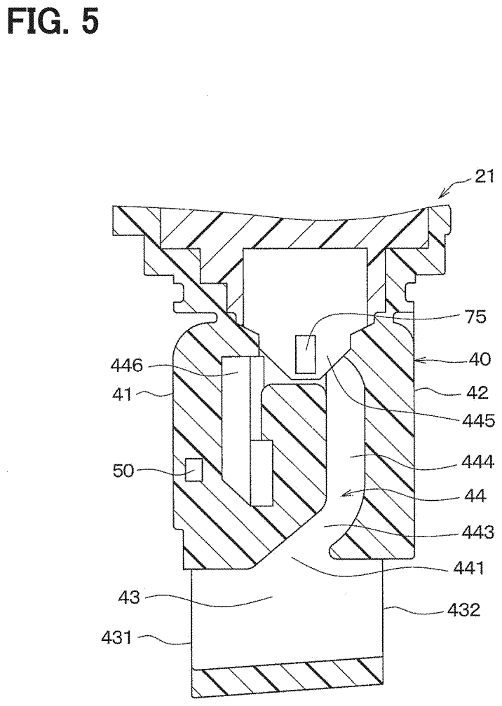

As shown in FIGS. 2 to 5, the flow rate measurement main passage inlet 431 is formed at the housing base surface 41 and introduces a portion of the air, which flows in the air intake passage 111, into the flow rate measurement main passage 43. As shown in FIG. 5, the flow rate measurement main passage 43 is communicated with the flow rate measurement main passage inlet 431 and the flow rate measurement main passage outlet 432. As shown in FIGS. 3 to 5, the flow rate measurement main passage outlet 432 is formed at the housing back surface 42.

As shown in FIG. 5, the flow rate measurement sub-passage inlet 441 is formed at an upper side of the flow rate measurement main passage 43 and introduces a portion of the air, which flows in the flow rate measurement main passage 43, into the flow rate measurement sub-passage 44. The flow rate measurement sub-passage 44 is a passage that is branched from a middle of the flow rate measurement main passage 43. The flow rate measurement sub-passage 44 includes an introducing portion 443, a rear vertical portion 444, a return portion 445 and a front vertical portion 446. The introducing portion 443 is connected to the flow rate measurement sub-passage inlet 441 and extends from the flow rate measurement sub-passage inlet 441 in an upward direction and also in a direction that is directed from the flow rate measurement sub-passage inlet 441 toward the housing back surface 42. Thereby, a portion of the air, which flows in the flow rate measurement main passage 43, can be easily introduced into the flow rate measurement sub-passage 44. The rear vertical portion 444 is connected to an end part of the introducing portion 443, which is opposite to the flow rate measurement sub-passage inlet 441, and the rear vertical portion 444 extends from this end part of the introducing portion 443 in the upward direction. The return portion 445 is connected to an end part of the rear vertical portion 444, which is opposite to the introducing portion 443, and the return portion 445 extends from this end part of the rear vertical portion 444 toward the housing base surface 41. The front vertical portion 446 is connected to an end part of the return portion 445, which is opposite to the rear vertical portion 444, and the front vertical portion 446 extends from this end part of the return portion 445 in the downward direction. In a cross-sectional view shown in FIG. 5, in order to dearly indicate the respective passages, an outline of the flow rate measurement sub-passage inlet 441, an outline of the secondary physical quantity measurement passage outlet 502 described later, and an outline of the circuit board 76 are omitted.

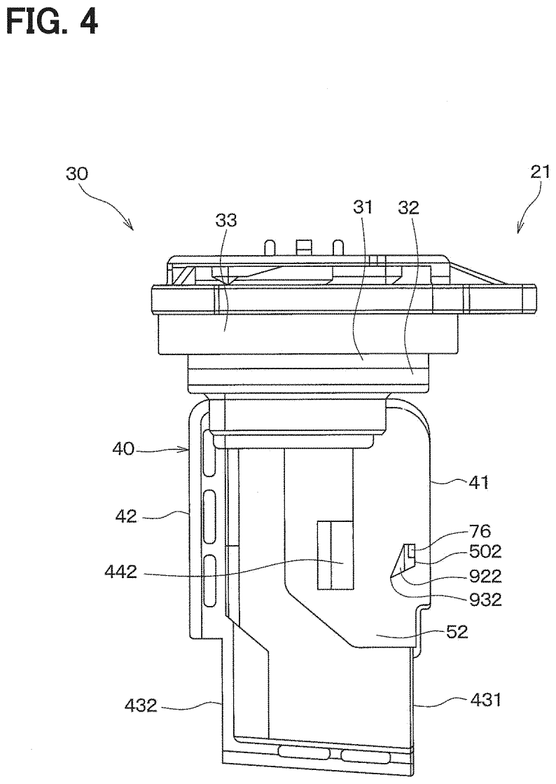

As shown in FIGS. 3 and 4, the flow rate measurement sub-passage outlets 442 are respectively formed at the primary housing lateral surface 51 and the secondary housing lateral surface 52 and are communicated with the front vertical portion 446 and the outside of the housing 30.

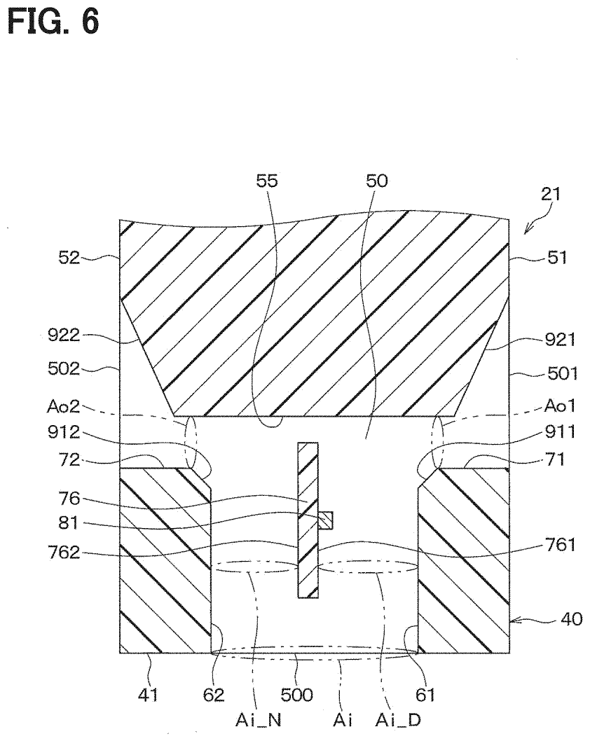

As shown in FIG. 2, the physical quantity measurement passage inlet 500 is formed at the housing base surface 41 at a location, which is on the upper side, i.e., the terminal 35 side of the flow rate measurement main passage inlet 431. The physical quantity measurement passage inlet 500 introduces a portion of the air, which flows in the air intake passage 111, into the physical quantity measurement passage 50. Furthermore, as shown in FIG. 6, the physical quantity measurement passage inlet 500 has a primary inlet inner surface 61 and a secondary inlet inner surface 62. The primary inlet inner surface 61 is located on one side of the physical quantity measurement passage inlet 500, at which the primary housing lateral surface 51 is placed, and the primary inlet inner surface 61 is connected to the housing base surface 41. The secondary inlet inner surface 62 is located on the other side of the physical quantity measurement passage inlet 500, at which the secondary housing lateral surface 52 is placed, and the secondary inlet inner surface 62 is connected to the housing base surface 41.

As shown in FIGS. 5 and 6, the physical quantity measurement passage 50 is communicated with the physical quantity measurement passage inlet 500 and is also communicated with the primary physical quantity measurement passage outlet 501 and the secondary physical quantity measurement passage outlet 502. Furthermore, as shown in FIG. 6, the physical quantity measurement passage 50 has a physical quantity measurement passage inner surface 55. The physical quantity measurement passage inner surface 55 is an inner surface of the physical quantity measurement passage 50 located on the housing back surface 42 side.

As shown in FIGS. 3 and 6, the primary physical quantity measurement passage outlet 501, the number of which is one, is formed at the primary housing lateral surface 51. Furthermore, as shown in FIG. 6, the primary physical quantity measurement passage outlet 501 has a primary outlet inner surface 71. The primary outlet inner surface 71 is located at a side of the primary physical quantity measurement passage outlet 501, at which the housing base surface 41 is placed, and the primary outlet inner surface 71 is connected to the primary housing lateral surface 51.

As shown in FIGS. 4 and 6, the secondary physical quantity measurement passage outlet 502, the number of which is one, is formed at the secondary housing lateral surface 52. Furthermore, as shown in FIG. 6, the secondary physical quantity measurement passage outlet 502 has a secondary outlet inner surface 72. The secondary outlet inner surface 72 is located at a side of the secondary physical quantity measurement passage outlet 502, at which the housing base surface 41 is placed, and the secondary outlet inner surface 72 is connected to the secondary housing lateral surface 52.

As shown in FIG. 5, the flow rate sensing device 75 is installed in the return portion 445 of the flow rate measurement sub-passage 44 and is configured to output a signal that corresponds to the flow rate of the air flowing in the flow rate measurement sub-passage 44. Specifically, the flow rate sensing device 75 includes a semiconductor that has a heating element and a thermosensitive element. This semiconductor contacts the air flowing in the flow rate measurement sub-passage 44, and thereby heat transmission occurs between the semiconductor and the air flowing in the flow rate measurement sub-passage 44. Due to this heat transmission, the temperature of the semiconductor changes. This temperature change correlates to the flow rate of the air flowing in the flow rate measurement sub-passage 44. Therefore, at the flow rate sensing device 75, a signal, which corresponds to this temperature change, is outputted, and thereby the flow rate sensing device 75 outputs a signal that corresponds to the flow rate of the air flowing in the flow rate measurement sub-passage 44. Furthermore, the flow rate sensing device 75 is electrically connected to the other end part of the corresponding terminal 35. In this way, the output signal of the flow rate sensing device 75 is transmitted to the electronic control device 18 through the terminal 35.

The circuit board 76 is, for example, a printed circuit board made of glass, epoxy resin, or the like and is electrically connected to the other end parts of the corresponding terminals 35. Furthermore, as shown in FIGS. 2 and 6, the circuit board 76 is placed at the physical quantity measurement passage inlet 500 and the physical quantity measurement passage 50. Also, the circuit board 76 is opposed to the primary physical quantity measurement passage outlet 501 the secondary physical quantity measurement passage outlet 502 the primary inlet inner surface 61 and the secondary inlet inner surface 62. Furthermore, an end part of the circuit board 76, which is located on the primary inlet inner surface 61 side, will be referred to as a primary circuit board end part 761. Furthermore, an end part of the circuit board 76, which is located on the secondary inlet inner surface 62 side, will be referred to as a secondary circuit board end part 762.

The physical quantity sensing device 81 is installed to the primary circuit board end part 761 of the circuit board 76 and is opposed to the primary inlet inner surface 61. The physical quantity sensing device 81 outputs a signal that corresponds to the physical quantity of the air which flows in the physical quantity measurement passage inlet 500. In this instance, the physical quantity of the air, which flows in the physical quantity measurement passage inlet 500, is the temperature of the air which flows in the physical quantity measurement passage inlet 500. The physical quantity sensing device 81 includes, for example, a thermistor (not shown) and outputs a signal that corresponds to the temperature of the air which flows in the physical quantity measurement passage inlet 500. Furthermore, since the physical quantity sensing device 81 is installed to the circuit board 76, the output signal of the physical quantity sensing device 81 is transmitted to the electronic control device 18 through the circuit board 76 and the corresponding terminal 35.

Here, the physical quantity measurement passage inlet 500 is configured to generate a flow of the air, which flows from the physical quantity measurement passage inlet 500 toward the primary physical quantity measurement passage outlet 501, at the flow of the air at the primary inlet inner surface 61 side in the physical quantity measurement passage inlet 500. Specifically, the physical quantity measurement passage inlet 500 has a primary inlet rectifying surface 911. As shown in FIG. 6, the primary inlet rectifying surface 911 is connected to an end part of the primary inlet inner surface 61, which is located on the housing back surface 42 side, and an end part of the primary outlet inner surface 71, which is located on the physical quantity measurement passage inlet 500 side. Furthermore, the primary inlet rectifying surface 911 extends from the end part of the primary inlet inner surface 61, which is located on the housing back surface 42 side, toward the primary physical quantity measurement passage outlet 501. Here, the primary inlet rectifying surface 911 extends from the end part of the primary inlet inner surface 61, which is located on the housing back surface 42 side, in a direction directed toward both the primary housing lateral surface 51 and the housing back surface 42. Furthermore, the primary inlet rectifying surface 911 is tilted relative to the primary inlet inner surface 61 and is shaped in a form of a flat surface. The air at the primary inlet inner surface 61 side of the physical quantity measurement passage inlet 500 flows along the primary inlet rectifying surface 911. Therefore, the flow of the air, which flows from the physical quantity measurement passage inlet 500 toward the primary physical quantity measurement passage outlet 501, is generated at the flow of the air at the primary inlet inner surface 61 side in the physical quantity measurement passage inlet 500.

Furthermore, the physical quantity measurement passage inlet 500 generates a flow of the air, which flows from the physical quantity measurement passage inlet 500 toward the secondary physical quantity measurement passage outlet 502, at the flow of the air at the secondary inlet inner surface 62 side in the physical quantity measurement passage inlet 500. Specifically, the physical quantity measurement passage inlet 500 has a secondary inlet rectifying surface 912, The secondary inlet rectifying surface 912 is connected to an end part of the secondary inlet inner surface 62, which is located on the housing back surface 42 side, and an end part of the secondary outlet inner surface 72, which is located on the physical quantity measurement passage inlet 500 side. Furthermore, the secondary inlet rectifying surface 912 extends from the end part of the secondary inlet inner surface 62, which is located on the housing back surface 42 side, toward the secondary physical quantity measurement passage outlet 502. Here, the secondary inlet rectifying surface 912 extends from the end part of the secondary inlet inner surface 62, which is located on the housing back surface 42 side, in a direction directed toward the secondary housing lateral surface 52 and also toward the housing back surface 42. Furthermore, the secondary inlet rectifying surface 912 is tilted relative to the secondary inlet inner surface 62 and is shaped in a form of a flat surface. The air at the secondary inlet inner surface 62 side in the physical quantity measurement passage inlet 500 flows along the secondary inlet rectifying surface 912. Therefore, the flow of the air, which flows from the physical quantity measurement passage inlet 500 toward the secondary physical quantity measurement passage outlet 502, is generated at the flow of the air at the secondary inlet inner surface 62 side in the physical quantity measurement passage inlet 500.

Furthermore, the primary physical quantity measurement passage outlet 501 has a primary outlet rectifying surface 921 described later. The primary physical quantity measurement passage outlet 501 generates the flow of the air in a direction along the primary housing lateral surface 51 at the flow of the air in the primary physical quantity measurement passage outlet 501 when the air in the primary physical quantity measurement passage outlet 501 flows along the primary outlet rectifying surface 921. Here, it is assumed that the air in the air intake passage 111 flows around the air flow rate measurement device 21, and the air flows in a direction from the housing base surface 41 toward the housing back surface 42. In this case, each of the direction along the primary housing lateral surface 51 and the direction along the secondary housing lateral surface 52 is the direction directed from the housing base surface 41 toward the housing back surface 42.

Specifically, the primary outlet rectifying surface 921 is formed at a part of the primary physical quantity measurement passage outlet 501 located on the housing back surface 42 side. Furthermore, the primary outlet rectifying surface 921 is connected to an end part of the physical quantity measurement passage inner surface 55 located on the primary housing lateral surface 51 side and is also connected to the primary housing lateral surface 51. Furthermore, the primary outlet rectifying surface 921 extends from the end part of the physical quantity measurement passage inner surface 55, which is located on the primary housing lateral surface 51 side, in a direction directed toward both the primary housing lateral surface 51 and the housing back surface 42, Here, the primary outlet rectifying surface 921 is tilted relative to the physical quantity measurement passage inner surface 55 and is shaped in a form of a flat surface. Furthermore, the flow of the air in the direction along the primary housing lateral surface 51 is generated at the flow of the air in the primary physical quantity measurement passage outlet 501 when the air in the primary physical quantity measurement passage outlet 501 flows along the primary outlet rectifying surface 921.

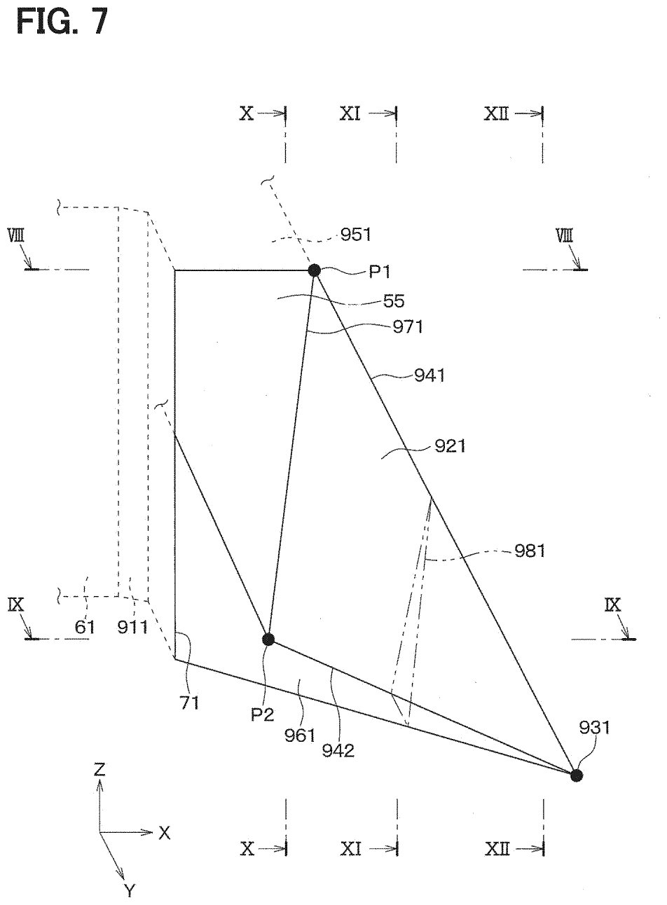

Here, as shown in FIGS. 3 and 7, an end of the primary outlet rectifying surface 921, which is located on the housing back surface 42 side and is on the lower side, will be referred to as a primary outlet end 931. As shown in FIG. 3, the primary outlet end 931 is an end of the primary outlet rectifying surface 921 located on the flow rate measurement main passage outlet 432 side. Furthermore, as shown in FIG. 7, the primary outlet rectifying surface 921 is shaped in a form of a triangle where an end edge of the primary outlet rectifying surface 921, which is located on the physical quantity measurement passage inner surface 55 side, is defined as a first bottom edge 971, and the primary outlet rectifying surface 921 has a first side edge 941 and a second side edge 942 which are connected to the first bottom edge 971. The primary outlet end 931 is an apex defined by the first side edge 941 and the second side edge 942 and serves as an apex of the triangle that is opposed to the first bottom edge 971.

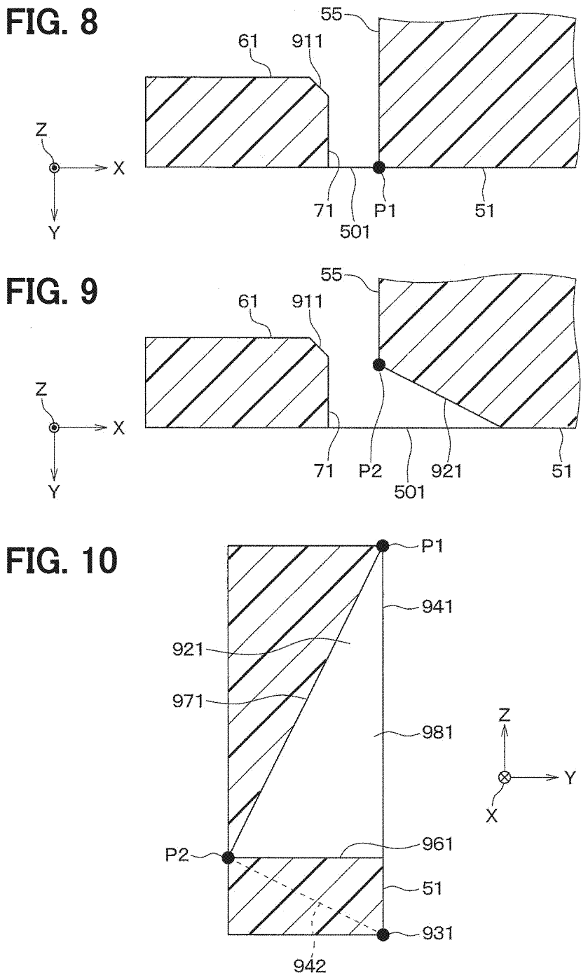

Furthermore, in order to clarify the shape of the primary outlet rectifying surface 921, an apex, which is defined by the first bottom edge 971 and the first side edge 941, will be referred to as a first apex P1 as shown in FIGS. 7 to 9. Furthermore, an apex, which is defined by the first bottom edge 971 and the second side edge 942, will be referred to as a second apex P2. As shown in FIGS. 8 and 9, the first bottom edge 971 is tilted relative to a top-to-bottom direction, and the first apex P1 is located on the primary housing lateral surface 51 side of the second apex P2.

Furthermore, as shown in FIG, 7, the primary physical quantity measurement passage outlet 501 has a primary outlet upper surface 951 and a primary outlet lower surface 961. The primary outlet upper surface 951 is formed at a part of the primary physical quantity measurement passage outlet 501 located on the upper side, i.e., the terminal 35 side. Furthermore, the primary outlet upper surface 951 is connected to an upper end part of the primary outlet inner surface 71 and an upper end part of the physical quantity measurement passage inner surface 55. The primary outlet lower surface 961 is formed at a part of the primary physical quantity measurement passage outlet 501 located on the lower side, i.e., the side opposite to the terminals 35. The primary outlet lower surface 961 is connected to a lower end part of the primary outlet inner surface 71 and the second side edge 942 of the primary outlet rectifying surface 921. Furthermore, the primary outlet lower surface 961 is tilted relative to the primary outlet upper surface 951 and extends from an end part of the primary outlet lower surface 961, which is connected to the primary outlet inner surface 71, toward the flow rate measurement main passage outlet 432, Furthermore, since the primary outlet lower surface 961 is connected to the primary outlet rectifying surface 921, the primary outlet end 931 serves as an end point of the primary outlet lower surface 961 located on the flow rate measurement main passage outlet 432 side. Therefore, the primary outlet end 931 is the end of the primary outlet rectifying surface 921 located on the flow rate measurement main passage outlet 432 side and is also the end of the primary outlet lower surface 961 located on the flow rate measurement main passage outlet 432 side. Thus, among the air flowing in the primary physical quantity measurement passage outlet 501, the air, which flows through the primary outlet end 931, is more likely to flow toward the flow rate measurement main passage outlet 432.

Furthermore, in the primary physical quantity measurement passage outlet 501, a primary flow passage 981, which is defined by the primary outlet rectifying surface 921 and the primary outlet lower surface 961, is formed. Since the primary outlet rectifying surface 921 is shaped in the form of the triangle, a size of the primary outlet rectifying surface 921 is progressively reduced from the first bottom edge 971 toward the primary outlet end 931. Therefore, as shown in FIGS. 10 to 12, a passage cross-sectional area of the primary flow passage 981 is progressively reduced in a direction directed from the housing base surface 41 toward the housing back surface 42, i.e., is progressively reduced in an axial direction of an X-axis. As a result, a flow velocity of the air, which is discharged from the primary physical quantity measurement passage outlet 501, becomes relatively high. In FIG. 7, the primary flow passage 981 is indicated by a dot-dot-dash line, so that the location of the primary flow passage 981 becomes clear.

Furthermore, in FIGS. 7 to 12, for the sake of clarity of the drawings, the direction, which is directed from the housing base surface 41 toward the housing back surface 42, is indicated as an X direction. Also, a direction, which is directed from the secondary housing lateral surface 52 toward the primary housing lateral surface 51, is indicated as a Y direction. Furthermore, the top-to-bottom direction is indicated as a Z direction.

Furthermore, as shown in FIG. 6, like the primary physical quantity measurement passage outlet 501, the secondary physical quantity measurement passage outlet 502 has a secondary outlet rectifying surface 922 described later. The secondary physical quantity measurement passage outlet 502 generates the flow of the air in a direction along the secondary housing lateral surface 52 at the flow of the air in the secondary physical quantity measurement passage outlet 502 when the air in the secondary physical quantity measurement passage outlet 502 flows along the secondary outlet rectifying surface 922.

Specifically, the secondary outlet rectifying surface 922 is formed at a part of the secondary physical quantity measurement passage outlet 502 located on the housing back surface 42 side. Furthermore, the secondary outlet rectifying surface 922 is connected to an end part of the physical quantity measurement passage inner surface 55 located on the secondary housing lateral surface 52 side and is also connected to the secondary housing lateral surface 52. Furthermore, the secondary outlet rectifying surface 922 extends from the end part of the physical quantity measurement passage inner surface 55, which is located on the secondary housing lateral surface 52 side, in a direction directed toward both the secondary housing lateral surface 52 and the housing back surface 42. Here, the secondary outlet rectifying surface 922 is tilted relative to the physical quantity measurement passage inner surface 55 and is shaped in a form of a flat surface. Furthermore, the flow of the air in the direction along the secondary housing lateral surface 52 is generated at the flow of the air in the secondary physical quantity measurement passage outlet 502 when the air in the secondary physical quantity measurement passage outlet 502 flows along the secondary outlet rectifying surface 922.

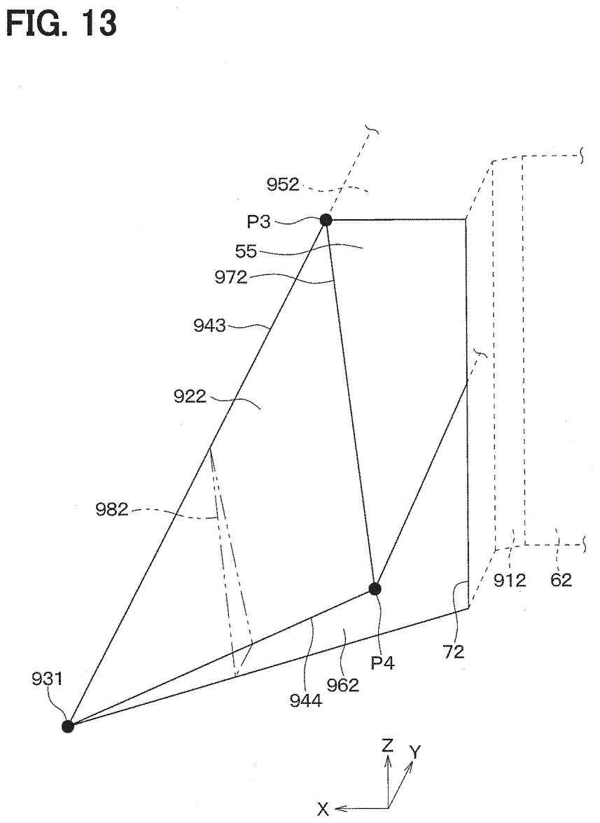

Here, as shown in FIGS. 4 and 13, an end of the secondary outlet rectifying surface 922, which is located on the housing back surface 42 side and is on the lower side, will be referred to as a secondary outlet end 932. As shown in FIG. 4, the secondary outlet end 932 is an end of the secondary physical quantity measurement passage outlet 502 located on the flow rate measurement main passage outlet 432 side.

Furthermore, as shown in FIG. 13, like the primary outlet rectifying surface 921, the secondary outlet rectifying surface 922 is shaped in a form of a triangle where an end edge of the secondary outlet rectifying surface 922, which is located on the physical quantity measurement passage inner surface 55 side, is defined as a second bottom edge 972. Therefore, the secondary outlet rectifying surface 922 has a third side edge 943 and a fourth side edge 944 which are connected to the second bottom edge 972. The secondary outlet end 932 is an apex defined by the third side edge 943 and the fourth side edge 944 and serves as an apex of the triangle that is opposed to the second bottom edge 972.

Furthermore, in order to clarify the shape of the secondary outlet rectifying surface 922, an apex, which is defined by the second bottom edge 972 and the third side edge 943, will be referred to as a third apex P3 as shown in FIG. 13. Furthermore, an apex, which is defined by the second bottom edge 972 and the fourth side edge 944, will be referred to as a fourth apex P4, Like the first bottom edge 971, the second bottom edge 972 is tilted relative to the top-to-bottom direction, and the third apex P3 is located on the secondary housing lateral surface 52 side of the fourth apex P4.

Furthermore, as shown in FIG. 13, the secondary physical quantity measurement passage outlet 502 has a secondary outlet upper surface 952 and a secondary outlet lower surface 962, The secondary outlet upper surface 952 is formed at a part of the secondary physical quantity measurement passage outlet 502 located on the upper side, i.e., the terminal 35 side. Furthermore, the secondary outlet upper surface 952 is connected to an upper end part of the secondary outlet inner surface 72 and an upper end part of the physical quantity measurement passage inner surface 55. The secondary outlet lower surface 962 is formed at a part of the secondary physical quantity measurement passage outlet 502 located on the lower side, i.e., the side opposite to the terminals 35. The secondary outlet lower surface 962 is connected to a lower end part of the secondary outlet inner surface 72 and the fourth side edge 944 of the secondary outlet rectifying surface 922. Furthermore, the secondary outlet lower surface 962 is tilted relative to the secondary outlet upper surface 952 and extends from an end part of the secondary outlet lower surface 962, which is connected to the secondary outlet inner surface 72, toward the flow rate measurement main passage outlet 432. Furthermore, since the secondary outlet lower surface 962 is connected to the secondary outlet rectifying surface 922, the secondary outlet end 932 serves as an end point of the secondary outlet lower surface 962 located on the flow rate measurement main passage outlet 432 side. Therefore, the secondary outlet end 932 is the end of the secondary outlet rectifying surface 922 located on the flow rate measurement main passage outlet 432 side and is also the end of the secondary outlet lower surface 962 located on the flow rate measurement main passage outlet 432 side. Thus, among the air flowing in the secondary physical quantity measurement passage outlet 502, the air, which flows through the secondary outlet end 932, is more likely to flow toward the flow rate measurement main passage outlet 432.

Furthermore, like the primary physical quantity measurement passage outlet 501, in the secondary physical quantity measurement passage outlet 502, a secondary flow passage 982, which is defined by the secondary outlet rectifying surface 922 and the secondary outlet lower surface 962, is formed. Since the secondary outlet rectifying surface 922 is shaped in the form of the triangle, a size of the secondary outlet rectifying surface 922 is progressively reduced from the second bottom edge 972 toward the secondary outlet end 932. Therefore, a passage cross-sectional area of the secondary flow passage 982 is progressively reduced in the direction directed from the housing base surface 41 toward the housing back surface 42, i.e., is progressively reduced in the axial direction of the X-axis. As a result, a flow velocity of the air, which is discharged from the secondary physical quantity measurement passage outlet 502, becomes relatively high. In FIG. 13, the secondary flow passage 982 is indicated by a dot-dot-dash line, so that the location of the secondary flow passage 982 becomes clear.

Furthermore, in FIG. 13, for the sake of clarity of the drawing, the direction, which is directed from the housing base surface 41 toward the housing back surface 42, is indicated as the X direction. Also, the direction, which is directed from the secondary housing lateral surface 52 toward the primary housing lateral surface 51, is indicated as the Y direction. Furthermore, the top-to-bottom direction is indicated as the Z direction.

The flow passages of the air, which flows through the physical quantity measurement passage inlet 500, the primary physical quantity measurement passage outlet 501 and the secondary physical quantity measurement passage outlet 502, have the following relationship. Here, in order to indicate the relationship of the flow passages of the air, which flows through the physical quantity measurement passage inlet 500, the primary physical quantity measurement passage outlet 501 and the secondary physical quantity measurement passage outlet 502, the following terms are defined.

As shown in FIG. 6, a passage cross-sectional area for the air, which flows between the end part of the primary inlet inner surface 61 located on the housing base surface 41 side and the end part of the secondary inlet inner surface 62 located on the housing base surface 41 side, is defined as an inlet passage cross-sectional area Ai. A passage cross-sectional area for the air, which flows between the primary inlet inner surface 61 and the primary circuit board end part 761, is defined as a measurement passage cross-sectional area Ai_D. A passage cross-sectional area for the air, which flows between the secondary inlet inner surface 62 and the secondary circuit board end part 762, is defined as a non-measurement passage cross-sectional area Ai_N. A passage cross-sectional area for the air, which flows between the end part of the primary outlet inner surface 71 located on the physical quantity measurement passage 50 side and the end part of the primary outlet rectifying surface 921 located on the physical quantity measurement passage 50 side, is defined as a primary outlet passage cross-sectional area Ao1. A passage cross-sectional area for the air, which flows between the end part of the secondary outlet inner surface 72 located on the physical quantity measurement passage 50 side and the end part of the secondary outlet rectifying surface 922 located on the physical quantity measurement passage 50 side, is defined as a secondary outlet passage cross-sectional area Ao2.

The physical quantity measurement passage inlet 500, the primary physical quantity measurement passage outlet 501 and the secondary physical quantity measurement passage outlet 502 have the following relationships. As indicated in the following relational expression (1-1), the primary outlet passage cross-sectional area Ao1 is smaller than the inlet passage cross-sectional area Ai and is smaller than the measurement passage cross-sectional area Ai_D. Thus, the flow velocity of the air, which flows in the primary physical quantity measurement passage outlet 501, tends to be higher than the flow velocity of the air, which flows in the physical quantity measurement passage inlet 500, and the flow velocity of the air, which flows in the physical quantity measurement passage 50. Furthermore, as indicated in the following relational expression (1-2), the secondary outlet passage cross-sectional area Ao2 is smaller than the inlet passage cross-sectional area Ai and is smaller than the non-measurement passage cross-sectional area Ai_N. Thus, the flow velocity of the air, which flows in the secondary physical quantity measurement passage outlet 502, tends to be higher than the flow velocity of the air, which flows in the physical quantity measurement passage inlet 500, and the flow velocity of the air, which flows in the physical quantity measurement passage 50.

$$\begin{matrix}Ao 1 < Ai\_D < Ai & ( 1 \text{-} 1 ) \\ Ao 2 < Ai\_N < Ai & ( 1 \text{-} 2 )\end{matrix}$$

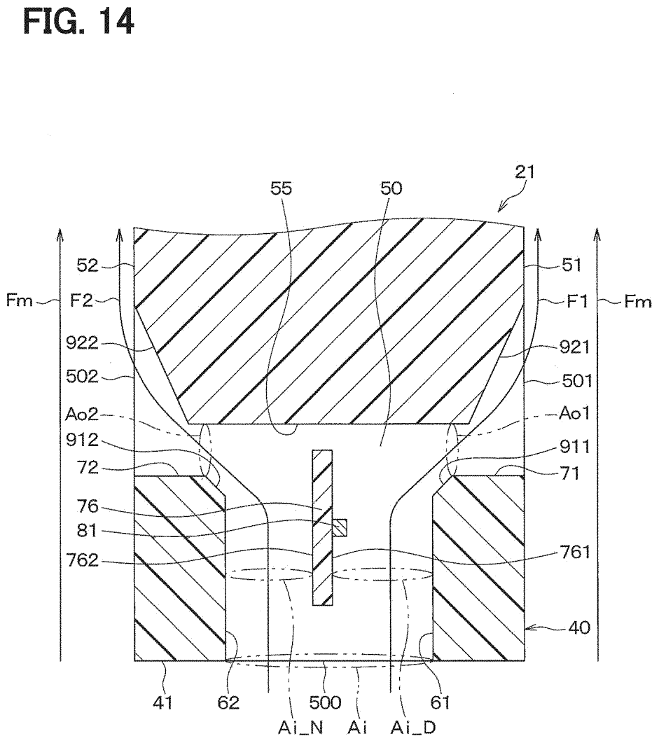

The air flow rate measurement device 21 is constructed in the above-described manner. Next, the measurement of the flow rate by the air flow rate measurement device 21 will be described. Furthermore, the measurement of the temperature by the air flow rate measurement device 21 will be described with reference to FIGS. 14 to 16. Here, as described above, it is assumed that the air in the air intake passage 111 is flowing around the air flow rate measurement device 21, and the air is flowing in the direction directed from the housing base surface 41 toward the housing back surface 42.

A portion of the air, which flows in the air intake passage 111, flows into the flow rate measurement main passage inlet 431. The air, which flows from the flow rate measurement main passage inlet 431, flows in the flow rate measurement main passage 43 toward the flow rate measurement main passage outlet 432. A portion of the air, which flows in the flow rate measurement main passage 43, is discharged to the outside of the housing 30 through the flow rate measurement main passage outlet 432.

Furthermore, another portion of the air, which flows in the flow rate measurement main passage 43, flows into the flow rate measurement sub-passage inlet 441. The air, which flows from the flow rate measurement sub-passage inlet 441, flows in the return portion 445 after passing through the introducing portion 443 and the rear vertical portion 444 of the flow rate measurement sub-passage 44. A portion of the air, which flows in the return portion 445, contacts the flow rate sensing device 75. Due to the contact of the flow rate sensing device 75 with the air, the flow rate sensing device 75 outputs a signal that corresponds to the flow rate of the air, which flows in the flow rate measurement sub-passage 44. The output signal of the flow rate sensing device 75 is transmitted to the electronic control device 18 through the corresponding terminal 35. Furthermore, a portion of the air, which flows in the return portion 445, is discharged to the outside of the housing 30 through the front vertical portion 446 and the flow rate measurement sub-passage outlets 442 of the flow rate measurement sub-passage 44,

Furthermore, a portion of the air, which flows in the air intake passage 111, flows into the physical quantity measurement passage inlet 500. As shown in FIG. 9, a portion of the air, which flows in the physical quantity measurement passage inlet 500, flows between the primary inlet inner surface 61 and the primary circuit board end part 761. A portion of the air, which flows between the primary inlet inner surface 61 and the primary circuit board end part 761, contacts the physical quantity sensing device 81.

The physical quantity sensing device 81 outputs a signal that corresponds to the temperature of the air which flows in the physical quantity measurement passage inlet 500. The output signal of the physical quantity sensing device 81 is transmitted to the electronic control device 18 through the circuit board 76 and the corresponding terminal 35. Furthermore, the air, which flows between the primary inlet inner surface 61 and the primary circuit board end part 761, then flows along the primary inlet rectifying surface 911, Thus, the physical quantity measurement passage inlet 500 generates the flow of the air, which flows from the physical quantity measurement passage inlet 500 toward the primary physical quantity measurement passage outlet 501, at the flow of the air at the primary inlet inner surface 61 side in the physical quantity measurement passage inlet 500. The air, which flows along the primary inlet rectifying surface 911, then flows in the primary physical quantity measurement passage outlet 501. The air, which flows in the primary physical quantity measurement passage outlet 501, flows along the primary outlet rectifying surface 921, Therefore, the primary physical quantity measurement passage outlet 501 generates the flow of the air in the direction along the primary housing lateral surface 51 at the flow of the air in the primary physical quantity measurement passage outlet 501. Then, the air, which flows along the primary outlet rectifying surface 921, is discharged from the primary physical quantity measurement passage outlet 501 and merges with the flow of the air flowing in the direction along the primary housing lateral surface 51. In FIG. 14, a flow of the air in the direction along the primary housing lateral surface 51 is indicated by Fm. Furthermore, as recited above, the direction along the primary housing lateral surface 51 is the direction directed from the housing base surface 41 toward the housing back surface 42. Furthermore, the flow of the air between the primary inlet inner surface 61 and the primary circuit board end part 761 is indicated by F1.

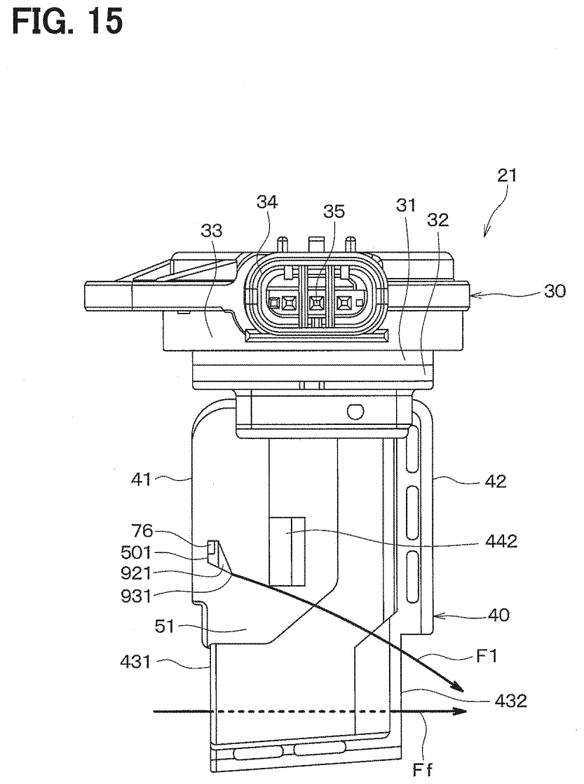

Also, as indicated in FIG. 15, a portion of the air, which is discharged from the primary physical quantity measurement passage outlet 501, flows toward the flow rate measurement main passage outlet 432. The air, which flows toward the flow rate measurement main passage outlet 432, merges with the air discharged from the flow rate measurement main passage outlet 432. In FIG, 15, the flow of the air, which is discharged from the flow rate measurement main passage outlet 432, is indicated by Ff. Furthermore, the flow of the air, which flows from the primary physical quantity measurement passage outlet 501 toward the flow rate measurement main passage outlet 432, corresponds to the flow of the air between the primary inlet inner surface 61 and the primary circuit board end part 761 and is indicated by F1.

Furthermore, as indicated in FIG. 14, a portion of the air, which flows in the physical quantity measurement passage inlet 500, flows between the secondary inlet inner surface 62 and the secondary circuit board end part 762. The air, which flows between the secondary inlet inner surface 62 and the secondary circuit board end part 762, then flows along the secondary inlet rectifying surface 912. Thus, the physical quantity measurement passage inlet 500 generates the flow of the air, which flows from the physical quantity measurement passage inlet 500 toward the secondary physical quantity measurement passage outlet 502, at the flow of the air at the secondary inlet inner surface 62 side in the physical quantity measurement passage inlet 500, The air, which flows along the secondary inlet rectifying surface 912, then flows in the secondary physical quantity measurement passage outlet 502. The air, which flows in the secondary physical quantity measurement passage outlet 502, flows along the secondary outlet rectifying surface 922. Therefore, the secondary physical quantity measurement passage outlet 502 generates the flow of the air in the direction along the secondary housing lateral surface 52 at the flow of the air in the secondary physical quantity measurement passage outlet 502. Then, the air, which flows along the secondary outlet rectifying surface 922, is discharged from the secondary physical quantity measurement passage outlet 502 and merges with the flow of the air flowing in the direction along the secondary housing lateral surface 52. In FIG. 14, the flow of the air between the secondary inlet inner surface 62 and the secondary circuit board end part 762 is indicated by F2.

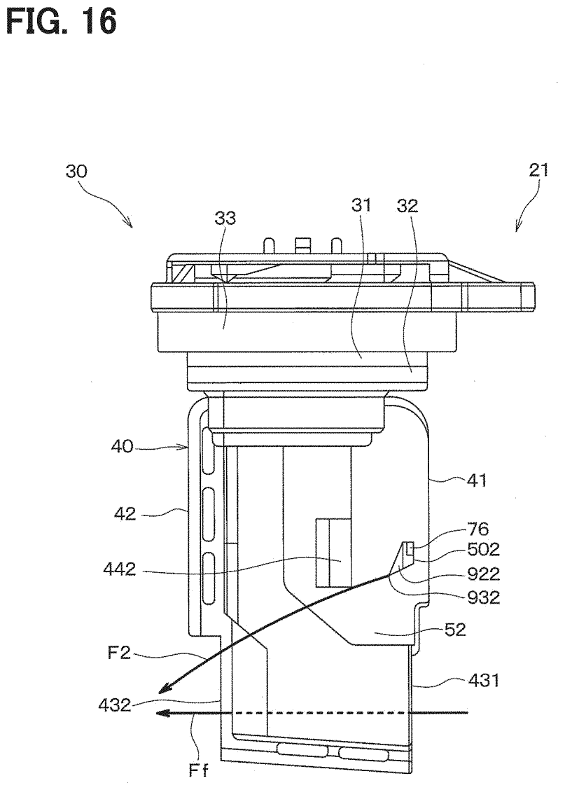

Also, as indicated in FIG. 16, a portion of the air, which is discharged from the secondary physical quantity measurement passage outlet 502, flows toward the flow rate measurement main passage outlet 432. The air, which flows toward the flow rate measurement main passage outlet 432, merges with the air discharged from the flow rate measurement main passage outlet 432. In FIG. 16, the flow of the air, which is discharged from the flow rate measurement main passage outlet 432, is indicated by Ff. Furthermore, the flow of the air, which flows from the secondary physical quantity measurement passage outlet 502 toward the flow rate measurement main passage outlet 432, corresponds to the flow of the air between the secondary inlet inner surface 62 and the secondary circuit board end part 762 and is indicated by F2.

As discussed above, the airflow rate measurement device 21 measures the flow rate of the air and the temperature of the air. At the air flow rate measurement device 21, a pressure loss of the air, which flows around the air flow rate measurement device 21, is reduced. The reduction of the pressure loss will be described hereinafter.

In the air flow rate measurement device 21, the primary physical quantity measurement passage outlet 501 generates the flow of the air in the direction along the primary housing lateral surface 51, at the flow of the air in the primary physical quantity measurement passage outlet 501. Therefore, an angle, which is defined between the flow direction of the air in the primary physical quantity measurement passage outlet 501 and the direction along the primary housing lateral surface 51, is reduced. Thus, the disturbance of the air, which flows along the primary housing lateral surface 51, by the air, which is discharged from the primary physical quantity measurement passage outlet 501, is limited. As a result, since the disturbance of the air flowing around the air flow rate measurement device 21 is limited, the pressure loss of the air flowing around the air flow rate measurement device 21 is reduced.

Furthermore, the secondary physical quantity measurement passage outlet 502 generates the flow of the air in the direction along the secondary housing lateral surface 52, at the flow of the air in the secondary physical quantity measurement passage outlet 502. Therefore, an angle, which is defined between the flow direction of the air in the secondary physical quantity measurement passage outlet 502 and the direction along the secondary housing lateral surface 52, is reduced. As a result, similar to the above-described one, since the disturbance of the air flowing around the air flow rate measurement device 21 is limited, the pressure loss of the air flowing around the air flow rate measurement device 21 is reduced.

Furthermore, in this instance, the engine 16 is placed on the downstream side of the air flow rate measurement device 21 in the flow direction of the air. Since the pressure loss of the air, which flows around the air flow rate measurement device 21, is reduced at the air flow rate measurement device 21, a reduction in the amount of the air suctioned into the engine 16 is limited. Therefore, the measurement accuracy of the air flow rate measurement device 21 for measuring the flow rate of the air to be suctioned into the engine 16 is improved. As a result, it is possible to improve the controllability and the combustion performance of the engine 16 which are based on the flow rate of the air measured by the air flow rate measurement device 21.

Furthermore, the circuit board 76 is a printed circuit board. Since the printed circuit board is in a form of a relatively thin plate, it is relatively difficult to process the printed circuit board into a shape that conforms the streamline of air. Moreover, since the processing of the printed circuit board is relatively difficult, the dimensional accuracy of the printed circuit board is relatively low. Due to the difficulty of processing on the printed circuit board and the low dimensional accuracy of the printed circuit board, the air around the printed circuit board tends to be unstable. Therefore, in the structure of the previously proposed sensor device, since this unstable flow of the air merges with the flow of the air around the sensor, the air flowing around the sensor tends to be disturbed. However, in the air flow rate measurement device 21, as described above, the air, which is discharged from the primary physical quantity measurement passage outlet 501, and the air, which is discharged from the secondary physical quantity measurement passage outlet 502, are rectified. Therefore, even when the physical quantity sensing device 81 is installed to the circuit board 76, it is possible to limit the disturbance of the air flowing around the air flow rate measurement device 21.

Furthermore, the air flow rate measurement device 21 can provide the following advantages (1) to (6).

(1) The primary physical quantity measurement passage outlet 501 has the primary outlet rectifying surface 921 that is configured to generate the flow of the air in the direction along the primary housing lateral surface 51 at the flow of the air in the primary physical quantity measurement passage outlet 501. Furthermore, the secondary physical quantity measurement passage outlet 502 has the secondary outlet rectifying surface 922 that is configured to generate the flow of the air in the direction along the secondary housing lateral surface 52 at the flow of the air in the secondary physical quantity measurement passage outlet 502. Here, each of the primary outlet rectifying surface 921 and the secondary outlet rectifying surface 922 is shaped in the form of the flat surface. Therefore, the primary outlet rectifying surface 921 and the secondary outlet rectifying surface 922 can be relatively easily formed.

(2) The flow rate measurement main passage inlet 431 is located on the opposite side of the physical quantity measurement passage inlet 500 which is opposite to the terminals 35. Furthermore, when the air flow rate measurement device 21 is installed to the air intake pipe 11, the flow rate measurement main passage inlet 431 is positioned at the center of the air intake passage 111 in the radial direction of the air intake pipe 11. Therefore, the flow rate measurement main passage inlet 431 can introduce the air, which has the relatively high flow velocity among the air flowing in the air intake passage 111, into the flow rate measurement main passage 43. When the air, which has the relatively high flow velocity, flows in the flow rate measurement main passage 43, the air is easily introduced into the flow rate measurement sub-passage 44. Therefore, the measurement accuracy of the air flow rate by the flow rate sensing device 75 is improved.

(3) The primary outlet end 931 is located between the primary physical quantity measurement passage outlet 501 and the flow rate measurement main passage outlet 432 and forms the flow passage of the air which flows from the primary physical quantity measurement passage outlet 501 toward the flow rate measurement main passage outlet 432. Therefore, the air, which is discharged from the primary physical quantity measurement passage outlet 501, merges with the air which is discharged from the flow rate measurement main passage outlet 432, Furthermore, the secondary outlet end 932 is located between the secondary physical quantity measurement passage outlet 502 and the flow rate measurement main passage outlet 432 and forms the flow passage of the air which flows from the secondary physical quantity measurement passage outlet 502 toward the flow rate measurement main passage outlet 432. Therefore, the air, which is discharged from the secondary physical quantity measurement passage outlet 502, merges with the air which is discharged from the flow rate measurement main passage outlet 432. Since the air, which is discharged from the primary physical quantity measurement passage outlet 501, and the air, which is discharged from the secondary physical quantity measurement passage outlet 502, merge with the air, which is discharged from the flow rate measurement main passage outlet 432, the variations in the flow velocity of the air, which flows on the downstream side of the flow rate measurement main passage outlet 432, are reduced. Therefore, the pressure loss of the air, which flows on the downstream side of the flow rate measurement main passage outlet 432, is reduced, and the pressure loss of the air, which flows around the air flow rate measurement device 21, is reduced.

Furthermore, by reducing the pressure loss of the air, which flows on the downstream side of the flow rate measurement main passage outlet 432, the fluctuation of the pressure of the air at the flow rate measurement main passage outlet 432, is reduced. Therefore, the flow of the air, which flows in the flow rate measurement main passage 43, is less likely to change. Since the flow of the air, which flows in the flow rate measurement main passage 43, is less likely to change, the flow of the air, which flows in the flow rate measurement sub-passage 44, is less likely to change. Therefore, the variations in the output signal of the flow rate sensing device 75 are reduced, and thereby the measurement accuracy of the flow rate sensing device 75 for the flow rate of the air, which flows in the flow rate measurement sub-passage 44, is improved.

(4) In the primary physical quantity measurement passage outlet 501, the primary flow passage 981, which is defined by the primary outlet rectifying surface 921 and the primary outlet lower surface 961, is formed. The passage cross-sectional area of the primary flow passage 981 is progressively reduced in the direction directed from the housing base surface 41 toward the housing back surface 42. As a result, the flow velocity of the air, which is discharged from the primary physical quantity measurement passage outlet 501, becomes relatively high. Thus, a difference between the flow velocity of the air, which is discharged from the primary physical quantity measurement passage outlet 501, and the flow velocity of the air, which flows along the primary housing lateral surface 51, can be reduced. Therefore, the disturbance of the air, which flows along the primary housing lateral surface 51, by the air, which is discharged from the primary physical quantity measurement passage outlet 501, is limited. Similarly, in the secondary physical quantity measurement passage outlet 502, the secondary flow passage 982, which is defined by the secondary outlet rectifying surface 922 and the secondary outlet lower surface 962, is formed. The passage cross-sectional area of the secondary flow passage 982 is progressively reduced in the direction directed from the housing base surface 41 toward the housing back surface 42. As a result, the flow velocity of the air, which is discharged from the secondary physical quantity measurement passage outlet 502, becomes relatively high. Thus, similar to the above-described one, the disturbance of the air, which flows along the secondary housing lateral surface 52, by the air, which is discharged from the secondary physical quantity measurement passage outlet 502, is limited.

(5) The primary outlet passage cross-sectional area Ao1 is smaller than the inlet passage cross-sectional area Ai and is smaller than the measurement passage cross-sectional area Ai_D. Therefore, it is possible to increase the flow velocity of the air, which flows in the primary physical quantity measurement passage outlet 501, in comparison to the flow velocity of the air, which flows in the physical quantity measurement passage inlet 500, and the flow velocity of the air, which flows in the physical quantity measurement passage 50. Thereby, the flow velocity of the air, which is discharged from the primary physical quantity measurement passage outlet 501, can be increased. Thus, the difference between the flow velocity of the air, which is discharged from the primary physical quantity measurement passage outlet 501, and the flow velocity of the air, which flows along the primary housing lateral surface 51, can be reduced. Therefore, the disturbance of the air, which flows along the primary housing lateral surface 51, by the air, which is discharged from the primary physical quantity measurement passage outlet 501, is limited. Furthermore, the secondary outlet passage cross-sectional area Ao2 is smaller than the inlet passage cross-sectional area Ai and is smaller than the non-measurement passage cross-sectional area Ai_N. Thus, similar to the above-described one, the disturbance of the air, which flows along the secondary housing lateral surface 52, by the air, which is discharged from the secondary physical quantity measurement passage outlet 502, is limited.

(6) The physical quantity measurement passage inlet 500 generates the flow of the air, which flows from the physical quantity measurement passage inlet 500 toward the primary physical quantity measurement passage outlet 501, at the flow of the air at the primary inlet inner surface 61 side in the physical quantity measurement passage inlet 500. The physical quantity measurement passage inlet 500 facilitates the flow of air from the physical quantity measurement passage inlet 500 to the primary physical quantity measurement passage outlet 501 through the physical quantity measurement passage 50. Therefore, the pressure loss of the air, which flows through the physical quantity measurement passage inlet 500, the physical quantity measurement passage 50 and the primary physical quantity measurement passage outlet 501, is reduced. Thus, the pressure difference between the air, which is discharged from the primary physical quantity measurement passage outlet 501, and the air, which flows along the primary housing lateral surface 51, in the direction along the primary housing lateral surface 51 is reduced. Therefore, the disturbance of the air, which flows along the primary housing lateral surface 51, by the air, which is discharged from the primary physical quantity measurement passage outlet 501, is limited. As a result, since the disturbance of the air flowing around the air flow rate measurement device 21 is limited, the pressure loss of the air flowing around the air flow rate measurement device 21 is reduced. Furthermore, the physical quantity measurement passage inlet 500 generates the flow of the air, which flows from the physical quantity measurement passage inlet 500 toward the secondary physical quantity measurement passage outlet 502, at the flow of the air at the secondary inlet inner surface 62 side in the physical quantity measurement passage inlet 500. Thus, similar to the above-described one, the disturbance of the air, which flows along the secondary housing lateral surface 52, by the air, which is discharged from the secondary physical quantity measurement passage outlet 502, is limited. As a result, since the disturbance of the air flowing around the air flow rate measurement device 21 is limited, the pressure loss of the air flowing around the air flow rate measurement device 21 is reduced.

### Second Embodiment

A second embodiment is the same as the first embodiment except for the configurations of the primary inlet rectifying surface, the secondary inlet rectifying surface, the primary outlet rectifying surface and the secondary outlet rectifying surface.

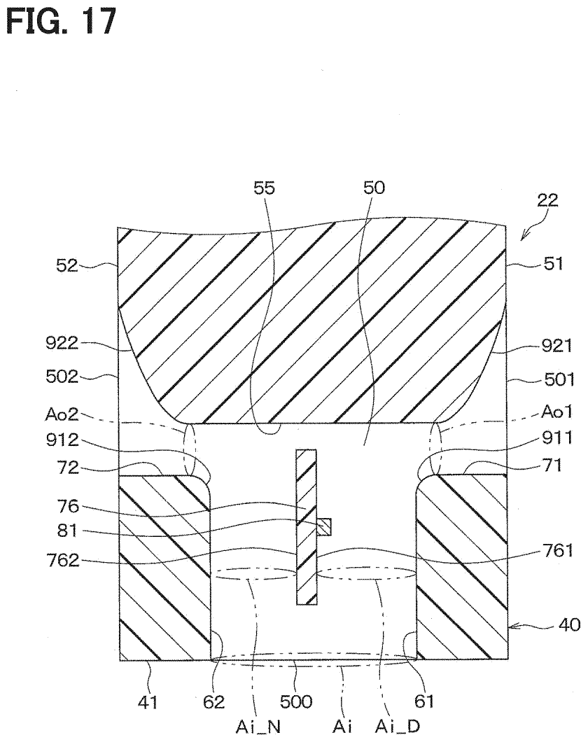

In the air flow rate measurement device 22 of the second embodiment, the primary inlet rectifying surface 911 is shaped in a form of a curved surface instead of the form of the flat surface. Specifically, as shown in FIG. 17, the primary inlet rectifying surface 911 is curved. Furthermore, a center of curvature of the primary inlet rectifying surface 911 is located at an inside of the bypass portion 40, and the primary inlet rectifying surface 911 is convexly curved.

Furthermore, like the primary inlet rectifying surface 911, the secondary inlet rectifying surface 912 is shaped in a form of a curved surface. Specifically, like the primary inlet rectifying surface 911, the secondary inlet rectifying surface 912 is convexly curved.

Furthermore, the primary outlet rectifying surface 921 is shaped in a form of a curved surface instead of the form of the flat surface. Specifically, the primary outlet rectifying surface 921 is curved. Furthermore, a center of curvature of the primary outlet rectifying surface 921 is located at an inside of the bypass portion 40, and the primary outlet rectifying surface 921 is convexly curved.

Also, like the primary outlet rectifying surface 921, the secondary outlet rectifying surface 922 is shaped in a form of a curved surface. Specifically, like the primary outlet rectifying surface 921, the secondary outlet rectifying surface 922 is convexly curved.

Even in the second embodiment, advantages, which are similar to those of the first embodiment, can be achieved, Furthermore, in the second embodiment, the primary outlet rectifying surface 921 and the secondary outlet rectifying surface 922 are convexly curved. Since the primary outlet rectifying surface 921 and the secondary outlet rectifying surface 922 do not have a sharp corner, the air can more easily flow along the primary outlet rectifying surface 921 and the secondary outlet rectifying surface 922 in comparison to the case where the primary outlet rectifying surface 921 and the secondary outlet rectifying surface 922 are respectively shaped in the form of the flat surface. Therefore, it is possible to limit a decrease in the flow velocity of each of the air, which is discharged from the primary physical quantity measurement passage outlet 501 and the air, which is discharged from the secondary physical quantity measurement passage outlet 502.

Furthermore, the primary inlet rectifying surface 911 and the secondary inlet rectifying surface 912 are convexly curved. Therefore, like the above-described one, it is possible to limit a decrease in the flow velocity of each of the air, which is discharged from the primary physical quantity measurement passage outlet 501, and the air, which is discharged from the secondary physical quantity measurement passage outlet 502.

### Third Embodiment

A third embodiment is the same as the first embodiment except for the configurations of the primary inlet rectifying surface, the secondary inlet rectifying surface, the primary outlet rectifying surface and the secondary outlet rectifying surface.

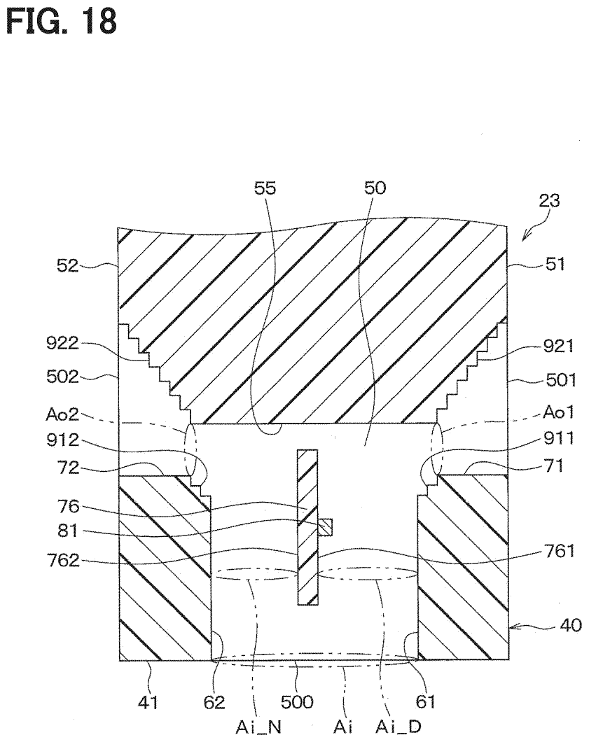

In the air flow rate measurement device 23 of the third embodiment, the primary inlet rectifying surface 911 is shaped in a form of a stepped surface instead of the form of the flat surface. Furthermore, as shown in FIG. 18, the primary inlet rectifying surface 911 has a plurality of steps. Also, like the primary inlet rectifying surface 911, the secondary inlet rectifying surface 912 is shaped in a form of a stepped surface.

Furthermore, the primary outlet rectifying surface 921 is shaped in a form of a stepped surface instead of the form of the flat surface. The primary outlet rectifying surface 921 has a plurality of steps. Also, like the primary outlet rectifying surface 921, the secondary outlet rectifying surface 922 is shaped in a form of a stepped surface.

Even in the third embodiment, advantages, which are similar to those of the first embodiment, can be achieved. Furthermore, in the third embodiment, each of the primary outlet rectifying surface 921 and the secondary outlet rectifying surface 922 is shaped in a form of a stepped surface. With this configuration, small vortexes are generated in the flow along the primary outlet rectifying surface 921 and the flow along the secondary outlet rectifying surface 922. Since generation of relatively large vortexes is suppressed by the generation of the small vortexes, it is possible to reduce the pressure loss of the air, which is discharged from the primary physical quantity measurement passage outlet 501, and the pressure loss of the air, which is discharged from the secondary physical quantity measurement passage outlet 502. Thus, the pressure difference between the air, which is discharged from the primary physical quantity measurement passage outlet 501, and the air, which flows along the primary housing lateral surface 51, in the direction along the primary housing lateral surface 51 is reduced. Furthermore, the pressure difference between the air, which is discharged from the secondary physical quantity measurement passage outlet 502, and the air, which flows along the secondary housing lateral surface 52, in the direction along the secondary housing lateral surface 52 is reduced, Therefore, the disturbance of the air, which flows along the primary housing lateral surface 51, by the air, which is discharged from the primary physical quantity measurement passage outlet 501, is limited, and the disturbance of the air, which flows along the secondary housing lateral surface 52, by the air, which is discharged from the secondary physical quantity measurement passage outlet 502, is limited.

Furthermore, each of the primary inlet rectifying surface 911 and the secondary inlet rectifying surface 912 is shaped in the form of the stepped surface. Therefore, like the above-described one, it is possible to reduce the pressure loss of the air, which flows from the physical quantity measurement passage inlet 500 to the primary physical quantity measurement passage outlet 501 and the secondary physical quantity measurement passage outlet 502 through the physical quantity measurement passage 50. Thus, it is possible to reduce the pressure loss of the air, which is discharged from the primary physical quantity measurement passage outlet 501, and the pressure loss of the air, which is discharged from the secondary physical quantity measurement passage outlet 502. As a result, the disturbance of the air, which flows along the primary housing lateral surface 51, by the air, which is discharged from the primary physical quantity measurement passage outlet 501, is limited, and the disturbance of the air, which flows along the secondary housing lateral surface 52, by the air, which is discharged from the secondary physical quantity measurement passage outlet 502, is limited.

### Other Embodiments

The present disclosure is not necessarily limited to the above embodiments, and the above embodiments may be suitably modified. Further, in each of the above embodiments, it is needless to say that the elements constituting the embodiment are not necessarily essential unless explicitly specified as being essential or in principle considered to be essential.

(1) In the above embodiments, the physical quantity sensing device 81 outputs the signal, which corresponds to the temperature of the air flowing in the physical quantity measurement passage 50. However, the physical quantity sensing device 81 should not be limited to the above configuration where the physical quantity sensing device 81 outputs the signal, which corresponds to the temperature of the air flowing in the physical quantity measurement passage 50, and the physical quantity sensing device 81 may be configured to output a signal, which corresponds to a relative humidity of the air flowing in the physical quantity measurement passage 50. Furthermore, the physical quantity sensing device 81 may output a signal, which corresponds to a pressure of the air flowing in the physical quantity measurement passage 50.

(2) In the above embodiments, the primary inlet inner surface 61, the secondary inlet inner surface 62, the primary outlet inner surface 71 and the secondary outlet inner surface 72 are respectively shaped in the form of the flat surface. However, the primary inlet inner surface 61, the secondary inlet inner surface 62, the primary outlet inner surface 71 and the secondary outlet inner surface 72 are not necessarily respectively shaped in the form of the flat surface but may be respectively shaped in a form of a curved surface or a form of a stepped surface.

(3) In the above embodiments, the primary physical quantity measurement passage outlet 501 is formed at the primary housing lateral surface 51, and the secondary physical quantity measurement passage outlet 502 is formed at the secondary housing lateral surface 52. Alternatively, the primary physical quantity measurement passage outlet 501 may be formed at the primary housing lateral surface 51, but the secondary physical quantity measurement passage outlet 502 may not be formed at the secondary housing lateral surface 52. Furthermore, the secondary physical quantity measurement passage outlet 502 may be formed at the secondary housing lateral surface 52, but the primary physical quantity measurement passage outlet 501 may not be formed at the primary housing lateral surface 51.

(4) In the above embodiments, the number of the primary physical quantity measurement passage outlet 501 is one, and the number of the secondary physical quantity measurement passage outlet 502 is one. However, the number of the primary physical quantity measurement passage outlet(s) 501 and the number of the secondary physical quantity measurement passage outlet(s) 502 should not be respectively limited to one and may be changed to two or more.

(5) In the above embodiments, the number of physical quantity measurement passage inlet 500 is one. However, the number of the physical quantity measurement passage inlet(s) 500 is not necessarily limited to one and may be changed to two or more. Furthermore, in the above embodiments, the physical quantity measurement passage inlet 500 is shaped in a form of an elongated rectangle. However, the shape of the physical quantity measurement passage inlet 500 is not necessarily limited to the form of the elongated rectangle and may be changed to a form of a polygon, a form of a circle or a form of an ellipse.

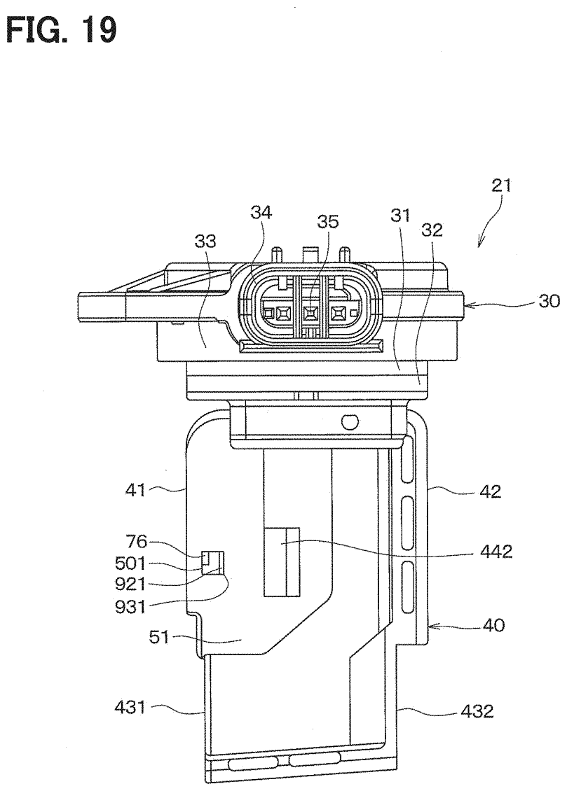

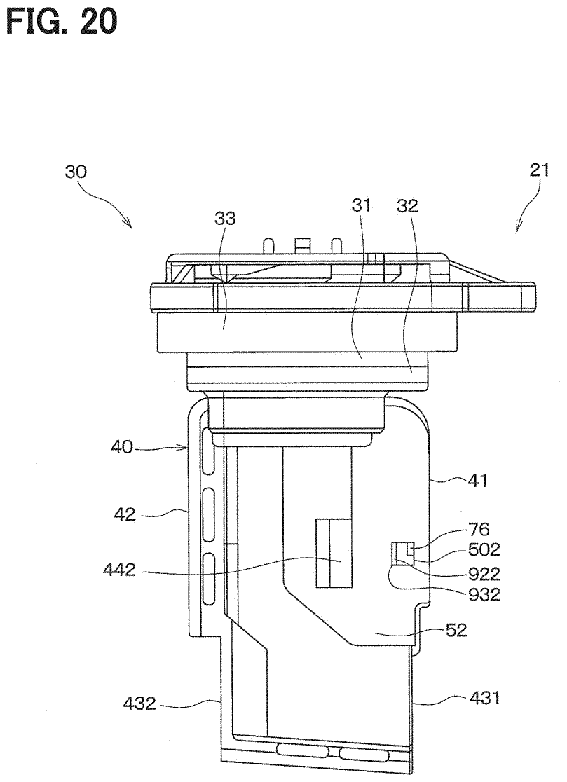

(6) Furthermore, in the above embodiments, each of the primary outlet rectifying surface 921 and the secondary outlet rectifying surface 922 is shaped in the form of the triangle. The shape of each of the primary outlet rectifying surface 921 and the secondary outlet rectifying surface 922 should not be limited to the form of the triangle and may be changed to a form of a polygon. For example, as shown in FIG. 19, the primary outlet rectifying surface 921 may be shaped in a form of a rectangle. Also, as shown in FIG. 20, the secondary outlet rectifying surface 922 may be shaped in a form of a rectangle.

(7) In the above embodiments, the circuit board 76 is opposed to each of the primary physical quantity measurement passage outlet 501, the secondary physical quantity measurement passage outlet 502, the primary inlet inner surface 61 and the secondary inlet inner surface 62. However, the circuit board 76 is not necessarily opposed to each of the primary physical quantity measurement passage outlet 501, the secondary physical quantity measurement passage outlet 502, the primary inlet inner surface 61 and the secondary inlet inner surface 62.

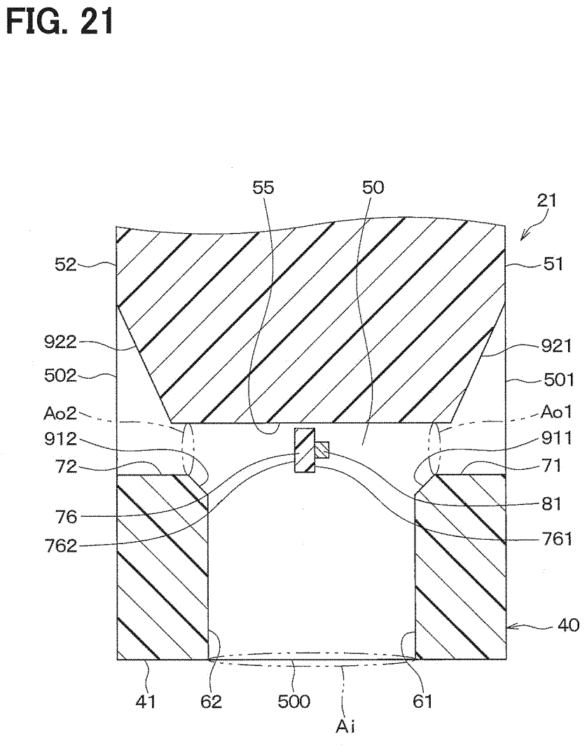

For example, as shown in FIG. 21, the circuit board 76 may be arranged in the physical quantity measurement passage 50 such that the circuit board 76 is opposed to the primary physical quantity measurement passage outlet 501 and the secondary physical quantity measurement passage outlet 502, and the circuit board 76 is not opposed to the primary inlet inner surface 61 and the secondary inlet inner surface 62. At this time, the circuit board 76 is located on the housing back surface 42 side of the primary inlet rectifying surface 911 and the secondary inlet rectifying surface 912. Furthermore, in this case, the physical quantity sensing device 81 is opposed to the primary physical quantity measurement passage outlet 501. Also, the measurement passage cross-sectional area Ai_D and the non-measurement passage cross-sectional area Ai_N are not defined.

Furthermore, for example, the circuit board 76 may be arranged in the physical quantity measurement passage inlet 500 such that the circuit board 76 is opposed to the primary inlet inner surface 61 and the secondary inlet inner surface 62, and the circuit board 76 is not opposed to the primary physical quantity measurement passage outlet 501 and the secondary physical quantity measurement passage outlet 502.

(8) It is possible to provide a combination of the airflow rate measurement device 21 of the first embodiment and the air flow rate measurement device 22 of the second embodiment. For example, the primary outlet rectifying surface 921 may be shaped in the form of the flat surface, and the secondary outlet rectifying surface 922 may be shaped in the form of the curved surface. Furthermore, It is possible to provide a combination of the air flow rate measurement device 21 of the first embodiment and the airflow rate measurement device 23 of the third embodiment. For example, the primary outlet rectifying surface 921 may be shaped in the form of the flat surface, and the secondary outlet rectifying surface 922 may be shaped in the form of the stepped surface. Furthermore, It is possible to provide a combination of the air flow rate measurement device 21 of the second embodiment and the air flow rate measurement device 23 of the third embodiment. For example, the primary outlet rectifying surface 921 may be shaped in the form of the curved surface, and the secondary outlet rectifying surface 922 may be shaped in the form of the stepped surface.

(9) In the above embodiments, the pipe extension 112 is shaped in the cylindrical tubular form. However, the pipe extension 112 is not necessarily shaped in the cylindrical tubular form. For example, the pipe extension 112 may be shaped in another tubular form, such as a polygonal tubular form.

(10) In the above embodiments, the holding portion 31 is shaped in the cylindrical tubular form. However, the holding portion 31 is not necessarily shaped in the cylindrical tubular form. For example, the holding portion 31 may be shaped in another tubular form, such as a polygonal tubular form.

(11) In the above embodiments, the connector cover 34 extends from the radially inner side toward the radially outer side of the holding portion 31. However, the connector cover 34 does not necessarily extend from the radially inner side toward the radially outer side of the holding portion 31. For example, the connector cover 34 may extend in the axial direction of the holding portion 31.

(12) In the above embodiments, the flow rate measurement sub-passage 44 is the passage that is branched from the middle of the flow rate measurement main passage 43. However, the flow rate measurement sub-passage 44 is not necessarily limited to the passage that is branched from the middle of the flow rate measurement main passage 43. For example, instead of communicating the flow rate measurement main passage 43 with the flow rate measurement main passage outlet 432, the flow rate measurement sub-passage 44 may be communicated with the flow rate measurement main passage outlet 432 such that the flow rate measurement main passage 43 and the flow rate measurement sub-passage 44 form one flow passage.

What is claimed is:

1. An air flow rate measurement device comprising:
a housing that has:
a base surface;
a back surface that is opposed to the base surface;
a lateral surface that is connected to an end part of the base surface and an end part of the back surface;
a flow rate measurement passage inlet that is formed at the base surface;
a flow rate measurement passage outlet that is formed at the back surface;
a flow rate measurement passage that is communicated with the flow rate measurement passage inlet and the flow rate measurement passage outlet;
a physical quantity measurement passage inlet that is formed at the base surface;
a physical quantity measurement passage outlet that is formed at the lateral surface; and
a physical quantity measurement passage that is communicated with the physical quantity measurement passage inlet and the physical quantity measurement passage outlet;
a flow rate sensing device that is configured to output a signal which corresponds to a flow rate of air flowing in the flow rate measurement passage; and
a physical quantity sensing device that is configured to output a signal which corresponds to a physical quantity of the air flowing in the physical quantity measurement passage, wherein:
the physical quantity measurement passage has a physical quantity measurement passage inner surface that is formed at a part of the physical quantity measurement passage located on a side where the back surface is placed; and
the physical quantity measurement passage outlet has an outlet rectifying surface that is connected to the lateral surface and an end part of the physical quantity measurement passage inner surface located on a side where the lateral surface is placed; and the physical quantity measurement passage outlet is configured to generate a flow of the air in a direction along the lateral surface at a flow of the air in the physical quantity measurement passage outlet when the air in the physical quantity measurement passage outlet flows along the outlet rectifying surface.

2. The air flow rate measurement device according to claim 1, wherein the outlet rectifying surface is shaped in a form of a flat surface that extends from the end part of the physical quantity measurement passage inner surface, which is located on the side where the lateral surface is placed, in a direction that is directed toward both the lateral surface and the back surface.

3. The air flow rate measurement device according to claim 1, wherein the outlet rectifying surface is convexly curved.

4. The air flow rate measurement device according to claim 1, wherein the outlet rectifying surface is shaped in a form of a stepped surface. The air flow rate measurement device according to claim 1, wherein:
the outlet rectifying surface has an outlet end formed at an end of the outlet rectifying surface located on the side where the back surface is placed; and
the outlet end is formed at an end of the physical quantity measurement passage outlet located on a side where the flow rate measurement passage outlet is placed, and the outlet end forms a flow passage of the air that flows from the physical quantity measurement passage outlet toward the flow rate measurement passage outlet.

6. The air flow rate measurement device according to claim 1, wherein:
the physical quantity measurement passage inlet has an inlet inner surface formed at a part of the physical quantity measurement passage inlet located on the side where the lateral surface is placed, and the physical quantity measurement passage outlet has an outlet inner surface formed at a part of the physical quantity measurement passage outlet located on the side where the base surface is placed; and
the inlet inner surface is one of two opposed inlet inner surfaces which are opposed to each other, and a passage cross-sectional area for the air, which flows between the outlet inner surface and the outlet rectifying surface; is smaller than a passage cross-sectional area for the air, which flows between the two opposed inlet inner surfaces.

7. The air flow rate measurement device according to claim 6, wherein:
the outlet inner surface is a primary outlet inner surface;
the physical quantity measurement passage outlet has:
a secondary outlet inner surface connected to the outlet rectifying surface and the primary outlet inner surface; and
a flow passage that is defined by the outlet rectifying surface and the secondary outlet inner surface; and
a cross-sectional area of the flow passage, which is defined by the outlet rectifying surface and the secondary outlet inner surface, is progressively reduced in a direction that is directed from the base surface toward the back surface.

8. The airflow rate measurement device according to claim 6, wherein the physical quantity measurement passage inlet has an inlet rectifying surface that is connected to the outlet inner surface and an end part of the inlet inner surface located on the side where the back surface is placed, and the physical quantity measurement passage inlet is configured to generate a flow of the air, which flows from the physical quantity measurement passage inlet toward the physical quantity measurement passage outlet, at a flow of the air in the physical quantity measurement passage inlet when the air in the physical quantity measurement passage inlet flows along the inlet rectifying surface.

9. The air flow rate measurement device according to claim 1, further comprising:
a circuit board on which the physical quantity sensing device is installed; and
a terminal that is connected to the circuit board, wherein:
the physical quantity measurement passage inlet is formed at a part of the base surface which is located between the terminal and the flow rate measurement passage inlet; and
in a state where the housing is installed to an air intake pipe, the flow rate measurement passage inlet is placed at a part of an air intake passage of the air intake pipe which is located at a radial center of the air intake pipe.
